(19) United States
(12) Patent Application Publication
(10) Pub. No.: US 2002/0069453 A1
(43) Pub. Date: Jun. 13, 2002

(54) Firefighter garment thermal liner material including hydrophobic fibers

(76) Inventors: Karen A. Kelleher, Mableton, GA (US); Michael T. Stanhope, Atlanta, GA (US)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 09/919,269

(22) Filed: Jul. 31, 2001

Related U.S. Application Data
(60) Provisional application No. 60/222,127, filed on Jul. 31, 2000.

(51) Int. Cl. A62B 17/00

(52) U.S. Cl. 2/458

(57) ABSTRACT

A protective garment including an outer shell made of flame resistant fibers, a moisture barrier adjacent to the outer layer, and a thermal liner adjacent to the moisture barrier. The thermal liner includes a face cloth layer and an insulation layer, wherein the insulation layer includes inherently hydrophobic fibers. The inherently hydrophobic fibers can comprise polyhalogenated ethylene fibers such as, for example, polytetrafluoroethylene.

### CROSS-REFERENCE TO RELATED APPLICATION

This application claims priority to copending U.S. provisional application entitled, “Firefighter Garment Thermal Liner Material Made From Hydrophobic Fibers,” having ser. No. 60/222,127, filed Jul. 31, 2000, which is entirely incorporated herein by reference.

### TECHNICAL FIELD

The present invention is generally related to firefighters garments and, more particularly, is related to firefighter turnout gear that includes a thermal liner comprising hydrophobic fibers.

### BACKGROUND OF THE INVENTION

Protective garments of many types are now well known for many and varied uses, such as suits for industrial workers, firefighters, forest firefighters, race car drivers, airplane pilots, and military personnel. Garments include not only complete, hermetic suits, but also individual garments such as trousers, jackets, gloves, boots, hats, head coverings, masks, etc. Generally, protective garments are designed to shield a wearer from a variety of environmental hazards. Firefighter garments are representative of such protective garments.

Firefighter garments, generally known as turnout gear, are designed primarily to prevent the firefighter from sustaining serious burns. A second significant threat to firefighters is heat stress. More firefighter deaths occur in the United States each year due to heat stress related conditions than due to burns. Heat stress related conditions include elevated body core temperature leading to heat prostration, increased blood pressure, heatstroke, and sometimes heart attack. As this second threat has become recognized, the fire service community has attempted to modify and improve turnout gear to minimize its contribution to heat stress.

Generally, turnout gear includes a coat and overalls. Turnout gear typically comprises three layers: an outer shell, a moisture barrier, and a thermal barrier. The outer shell layer is usually a woven fabric made from flame resistant fibers and is considered the firefighter's first line of defense. Not only should it resist flame, but it needs to be tough and durable so as not to be torn, unduly abraded, or snagged during normal firefighting activities.

The moisture barrier layer, while also flame resistant, is provided to prevent water from permeating and saturating the turnout gear. Excess moisture from the environment would laden the firefighter with extra weight and therefore increase his or her load. Such an increase in load is likely to increase the possibility of heat stress.

The thermal barrier liner is also flame resistant and offers the bulk of the thermal protection afforded by the ensemble. A traditional thermal barrier liner includes an insulation layer of flame resistant fibers quilted to a lightweight woven face cloth also made of flame resistant fibers.

During firefighting procedures, firefighters tend to perspire excessively. This perspiration is usually absorbed into the thermal liner of the garment ensemble to keep the firefighter feeling dry. However, this absorption of perspiration by the thermal liner creates several significant drawbacks. For example, perspiration absorption increases the drying time needed for the gear. Accordingly, if the firefighter must respond to a second incident on the same shift, the firefighter must wear a damp or wet garment, which is heavier and less comfortable than a dry garment. In addition to this disadvantage, a wet garment can increase the risk of injury to the firefighter. Specifically, a wet garment can store more thermal energy than a dry garment, thus making the firefighter more susceptible to compression burns. If the thermal liner can either stay drier or be dried in less time, the risk of compression burns may be decreased, while the comfort level of the garment increases.

To combat the drawbacks associated with perspiration absorption, at least one manufacturer has treated the insulation layer with hydrophobic finishes to shed moisture and avoid absorption. (U.S. Pat. No. 5,983,409). Unfortunately, over time, washing and wear deteriorate the hydrophobicity of the hydrophobically finished insulation layer, thereby permitting the thermal liner to absorb perspiration.

Thus, a heretofore unaddressed need exists for a liner material and garment that address the aforementioned deficiencies and inadequacies.

### SUMMARY OF THE INVENTION

Embodiments of the present invention provide for a protective garment that includes an outer shell made of flame resistant fibers, a moisture barrier adjacent to the outer layer, and a thermal liner adjacent to the moisture barrier.

The thermal liner includes a face cloth layer and an insulation layer, wherein the insulation layer includes inherently hydrophobic fibers. The inherently hydrophobic fibers include polyhalogenated ethylene fibers such as, for example, polytetrafluoroethylene. In addition, the insulation layer may include non-hydrophobic flame resistant fibers. In this regard, the composition of the insulation layer is at least about 50% inherently hydrophobic fiber by composition. Typically, the composition is at least about 85% inherently hydrophobic fiber by composition. The flame resistant fibers include, for example, meta-aramid fibers, para-aramid fibers, polybenzimidazole fibers, polybenzoxazole fibers, and melamine fibers.

Other systems, methods, features, and advantages of the present invention will be, or become, apparent to one with skill in the art upon examination of the following drawings and detailed description. It is intended that all such additional systems, methods, features, and advantages be included within this description, be within the scope of the present invention, and be protected by the accompanying claims.

### BRIEF DESCRIPTION OF THE DRAWINGS

The invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 illustrates a partial cut-away of a firefighter jacket.

FIG. 2 illustrates an exploded perspective of a portion of the jacket illustrated in FIG. 1.

FIGS. 3A and 3B illustrate a side-view of an embodiment of the thermal liner before and after needlepunching.

### DETAILED DESCRIPTION

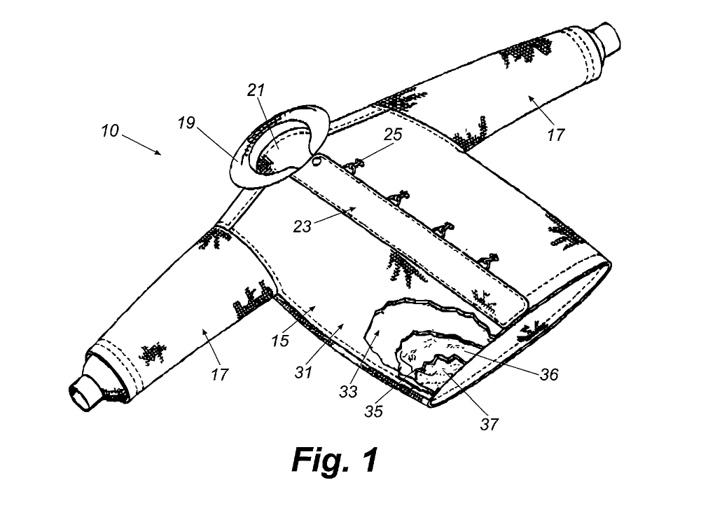

FIG. 1 illustrates a firefighter garment 10, in particular, a firefighter jacket 10. Although this specific garment is shown in FIG. 1 and identified therein, it is to be understood that the present invention is not limited to firefighter jackets, but pertains to all flame resistant garments for firefighters, EMS personnel, forest firefighters, race car drivers, airplane pilots, military personnel, and other persons that wear protective garments where the inner layers need to shed moisture and/or dry quickly. Accordingly, the principals disclosed herein also apply to overalls, jumpsuits, trousers, gloves, boots, hats, head coverings, masks, etc. Therefore, it will be appreciated that the firefighter jacket 10, illustrated in FIG. 1, is presented only as a demonstrative example of an embodiment of the present invention.

The firefighter jacket 10 depicted in FIG. 1 has a body portion 15, arms 17, collar 19 surrounding a neck opening 21, a chest flap 23, and hooks 25. The chest flap 23 can be closed, for example, with hooks 25 or other mechanical locking mechanisms, such as snaps, etc.

The body portion 15, arms 17, and collar 19 are made of an outer shell 31. As indicated in the cut-away of FIG. 1, inside the outer shell 31 is a moisture barrier 33 and a thermal liner 35. The outer shell 31 is typically constructed of flame and abrasion resistant fibers such as, for example, aramid, polybenzimidazole, polybenzoxazole, melamine, or blends thereof. Aramid fibers include meta- and para-aramid fibers. Generally, the outer shell 31 is finished with a water-resistant finish such as a perfluorohydrocarbon. Generally, the weight of the outer shell 31 can range from about 6 to about 8 ounces per square yard.

Generally, the moisture barrier 33 is constructed of a non-woven or woven flame resistant fabric composed of a flame resistant material such as, for example, aramid, polybenzimidazole, polybenzoxazole, melamine, or blends thereof. The moisture barrier 33 is typically laminated with polytetrafluoroethylene, polyurethane, or another appropriate laminate on one side, typically such that the polyurethane laminate layer faces the thermal liner 35. The weight of the moisture barrier 33 can range from about 4 to about 6 ounces per square yard.

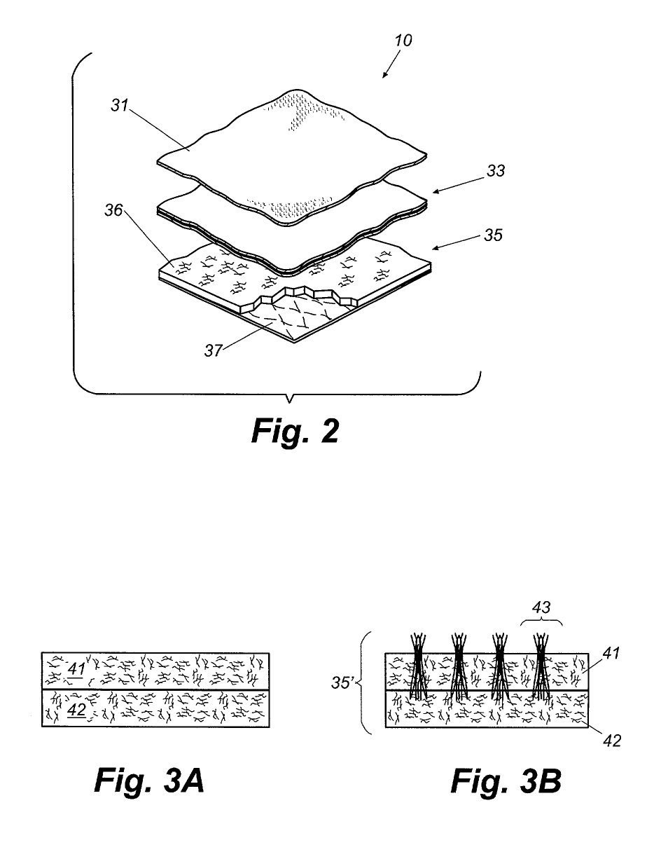

As indicated in FIG. 2, the thermal liner 35 includes an insulation layer 36 and a face cloth layer 37 that may be quilted together. The face cloth layer 37 can be constructed of a woven flame resistant fiber such as, for example, aramid, polybenzimidazole, polybenzoxazole, melamine, or blends thereof, and optionally can be finished with a hydrophilic finish that draws the perspiration off of the body. The weight of the face cloth 37 can range from about 1 to about 6 ounces per square yard. The insulation layer 36 preferably is constructed of an inherently hydrophobic fiber that has properties such as high thermal resistance (e.g. exposed to high temperatures (300° C.) without degradation, and high chemical resistance (e.g. chemically inert to acids, bases, solvents, etc.). Inherent hydrophobic fibers are capable of shedding moisture so that it is not absorbed into the firefighter jacket 10. Inherently hydrophobic fibers lack the affinity and/or the ability to absorb water. In contrast, fibers finished with a hydrophobic finish are not inherently hydrophobic and, as identified above, the finish tends to degrade over time, so that the finished fiber loses its hydrophobic characteristics. In contrast, inherently hydrophobic fibers do not lose their hydrophobic characteristics over time.

The insulation layer 36 is typically non-woven, but can be woven if textured to provide air pockets. The weight of the insulation layer 36 can range from about 1 to about 10 ounces per square yard. More particularly, the weight of the insulation layer 36 can range from about 3 to about 7 ounces per square yard, with about 6 ounces per square yard being preferred.

The insulation layer 36 can comprise 100% inherently hydrophobic fibers. By way of example, the inherently hydrophobic fibers can comprise polyhalogenated ethylene fibers such as, for example, polytetrafluoroethlylene fibers (e.g. TEFLON™ from E. I. Du Pont De Nemours & Co. or PROFILIN™ from Lenzing Fibers Corporation).

Alternatively, the insulation layer 36 can comprise a blend of inherently hydrophobic fibers and non-hydrophobic, flame resistant fibers such as, for example, aramid fibers, polybenzimidazole fibers, polybenzoxazole fibers, melamine fibers, or blends thereof. Typically, the blend includes enough inherently hydrophobic fibers so that the insulation layer 36 sheds moisture and limits the absorption of moisture. In this regard, the insulation layer, preferably, includes enough inherently hydrophobic fibers so that the thermal liner 35 does not become too heavy or absorb a quantity of water that could endanger the firefighter, as discussed above. By way of example, the composition of the insulation layer 36 can include about 50% inherently hydrophobic fiber and about 50% flame resistant fiber. Typically, the insulation layer 36 comprises about 85% to about 100% inherently hydrophobic fiber. In addition, the insulation layer 36 can include other fibers that serve other purposes such as anti-static fibers.

The blended insulation layer can be constructed by blending the inherently hydrophobic fibers with flame resistant fibers in a hopper, thereby forming an intimate blend. The intimate blend is used to form a web. The web can be fabricated into a fabric by chemical or mechanical techniques such as, needle punched techniques, hydro-entanglement techniques, and air-jet entanglement techniques.

Referring now to FIGS. 3A and 3B, illustrated is the needle punch construction technique that can be used to attach an inherently hydrophobic fiber web 42 to a flame resistant fiber web 41. As shown in these figures, this technique involves needle punching an inherently hydrophobic fiber web 42 with a flame resistant fiber web 41. After needle punching the two webs 42 and 41, a layered arrangement insulation layer 35′ is constructed in which tufts 43 of hydrophobic fibers extend out of the flame resistant fiber portion 41. It should be noted that other mechanical entanglement techniques and/or chemical techniques could be used instead of the needle punch construction technique. During the construction of a garment, the hydrophobic fiber portion 42, preferably, faces towards the face cloth layer 37. One advantage of this configuration is that less hydrophobic fibers are used, thereby reducing the cost of the insulation while still providing hydrophobic fibers facing the body so as to maintain the liner's ability to shed moisture. For example, the layered insulation layer 35′ can include at least about 30% inherently hydrophobic fiber web. Typically, the layered insulation layer 35′ can include between about 40% and about 50% inherently hydrophobic fiber web. Another advantage of this configuration is that the tufts 43 provide a boundary of hydrophobic fiber on the outer shell 31 side of the firefighter jacket 10, which reduces the amount of moisture absorbed from outer shell side of the insulation layer 35.

Constructing the insulation layer 36 with an appropriate amount of an inherently hydrophobic fiber is advantageous because moisture, typically sweat, is not absorbed by the firefighter jacket 10, which upon absorption causes the jacket 10 to become heavy and increase the chance of compression burns. Once the moisture contacts the inherently hydrophobic fiber, the moisture sheds off the fiber and travels down the jacket 10 due to gravity. After the firefighter jacket 10 is used, the jacket 10 may still have some moisture trapped, but not absorbed, within the insulation layer 36. In contrast to other insulation layers that dry slowly because the insulation layer absorbs moisture, the insulation layer 36 of embodiments of the present invention dries relatively fast as a result of the hydrophobicity of the inherently hydrophobic fibers included in the insulation layer 36. This can be important because a firefighter may be called to fight multiple fires in a shift and it is much safer and more comfortable for the firefighter to wear a dry jacket rather than a wet jacket.

Many variations and modifications may be made to the above-described embodiments of the invention without departing substantially from the spirit and principles of the invention. All such modifications and variations are intended to be included herein within the scope of this disclosure and the present invention and protected by the following claims.

Therefore, having thus described the invention, at least the following is claimed:

1. A protective garment comprising:
an outer shell made of flame resistant fibers;
a moisture barrier adjacent the outer shell; and
a thermal liner adjacent to the moisture barrier, the liner including inherently hydrophobic fibers.

2. The garment of claim 1, wherein the thermal liner includes a face cloth layer and an insulation layer, the insulation layer including the inherently hydrophobic fibers.

3. The garment of claim 2, wherein the insulation layer further includes non-hydrophobic flame resistant fibers.

4. The garment of claim 3, wherein the flame resistant fibers are selected from meta-aramid, para-aramid, polybenzimidazole, polybenzoxazole, and melamine.

5. The garment of claim 3, wherein the insulation layer includes at least about 50% inherently hydrophobic fibers by composition.

6. The garment of claim 3, wherein the insulation layer includes at least about 85% inherently hydrophobic fibers by composition.

7. The garment of claim 3, wherein the insulation layer includes an inherently hydrophobic fiber web and a non-hydrophobic flame resistant fiber web.

8. The garment of claim 7, wherein the inherently hydrophobic fiber web and the non-hydrophobic flame resistant fiber web are attached to one another by a mechanical entanglement technique to form a layered insulation layer.

9. The garment of claim 8, wherein the mechanical entanglement technique is a needle-punch technique.

10. The garment of claim 8, wherein the layered insulation layer includes at least about 30% inherently hydrophobic fiber web by composition.

11. The garment of claim 8, wherein the layered insulation layer includes in the range of about 40% to about 50% inherently hydrophobic fiber web by composition.

12. The garment of claim 7, wherein the inherently hydrophobic fiber web and the non-hydrophobic flame resistant fiber web are attached to one another by a chemical technique to form a layered insulation layer.

13. The garment of claim 2, wherein the face cloth has a weight of about 1 to about 6 ounces per square yard.

14. The garment of claim 2, wherein the insulation layer has a weight of about 1 to about 10 ounces per square yard.

15. The garment of claim 2, wherein the insulation layer has a weight of about 3 to about 7 ounces per square yard.

16. The garment of claim 2, wherein the insulation layer has a weight of about 6 ounces per square yard.

17. The garment of claim 1, wherein the inherently hydrophobic fibers include polytetrafluoroethylene fibers.

18. The garment of claim 1, wherein the inherently hydrophobic fibers include polyhalogenated ethylene fibers.

19. A thermal liner comprising:
a face cloth; and
an insulation layer attached to the face cloth, wherein the insulation layer includes inherently hydrophobic fibers.

20. The thermal liner of claim 19, wherein the inherently hydrophobic fibers comprise polytetrafluoroethylene fibers.

21. The thermal liner of claim 19, wherein the inherently hydrophobic fibers comprise polyhalogenated ethylene fibers.

22. The thermal liner of claim 19, wherein the insulation layer further includes nonhydrophobic flame resistant fibers.

23. The thermal liner of claim 22, wherein the insulation layer includes enough inherently hydrophobic fibers to shed moisture and limit absorption of moisture.

24. The thermal liner of claim 22, wherein the insulation layer includes at least about 50% inherently hydrophobic fibers by composition.

25. The thermal liner of claim 22, wherein the insulation layer includes at least about 85% inherently hydrophobic fibers by composition.

26. The thermal liner of claim 22, wherein the insulation layer includes an inherently hydrophobic fiber web and a non-hydrophobic flame resistant fiber web.

27. The thermal liner of claim 26, wherein the inherently hydrophobic fiber web and the non-hydrophobic flame resistant fiber web are attached to one another by a mechanical entanglement technique to form a layered insulation layer.

28. The thermal liner of claim 27, wherein the mechanical entanglement technique is a needle-punch technique.

29. The thermal liner of claim 27, wherein the layered insulation layer includes at least about 30% inherently hydrophobic fiber web by composition.

30. The thermal liner of claim 27, wherein the layered insulation layer includes in the range of about 40% to about 50% inherently hydrophobic fiber web by composition.

31. The thermal liner of claim 27, wherein the inherently hydrophobic fiber web and the non-hydrophobic flame resistant fiber web are attached to one another by a chemical technique to form a layered insulation layer.

32. The thermal liner of claim 19, wherein the face cloth has a weight of about 1 to about 6 ounces per square yard.

33. The thermal liner of claim 19, wherein the insulation layer has a weight of about 1 to about 10 ounces per square yard.

34. The thermal liner of claim 19, wherein the insulation layer has a weight of about 3 to about 7 ounces per square yard.

35. The thermal liner of claim 19, wherein the insulation layer has a weight of about 6 ounces per square yard.

36. A thermal liner comprising:
a face cloth; and
an insulation layer that includes polytetrafluoroethylene fibers.

37. The thermal liner of claim 36, wherein the insulation layer further includes non-hydrophobic flame resistant fibers.

38. The thermal liner of claim 37, wherein the flame resistant fibers are selected from meta-aramid, para-aramid, polybenzimidazole, polybenzoxazole, and melamine.

39. The thermal liner of claim 37, wherein the insulation layer includes at least about 50% polytetrafluoroethylene fiber by composition.

40. The thermal liner of claim 37, wherein the insulation layer includes at least about 85% polytetrafluoroethylene fiber by composition.

41. The thermal liner of claim 37, wherein the insulation layer includes a polytetrafluoroethylene web and a non-hydrophobic flame resistant fiber web.

42. The thermal liner of claim 41, wherein the polytetrafluoroethylene and the non-hydrophobic flame resistant fiber web are attached to one another by a mechanical entanglement technique to form a layered insulation layer.

43. The thermal liner of claim 42, wherein the mechanical entanglement technique is a needle-punch technique.

44. The thermal liner of claim 42, wherein the layered insulation layer includes at least about 30% polytetrafluoroethylene web by composition.

45. The thermal liner of claim 42, wherein the layered insulation layer includes in the range of about 40% to about 50% polytetrafluoroethylene web by composition.

46. The thermal liner of claim 27, wherein the inherently hydrophobic fiber web and the non-hydrophobic flame resistant fiber web are attached to one another by a chemical technique to form a layered insulation layer.

47. The thermal liner of claim 36, wherein the face cloth has a weight of about 1 to about 6 ounces per square yard.

48. The thermal liner of claim 36, wherein the insulation layer has a weight of about 1 to about 10 ounces per square yard.

49. The thermal liner of claim 36, wherein the insulation layer has a weight of about 3 to about 7 ounces per square yard.

50. The thermal liner of claim 36, wherein the insulation layer has a weight of about 6 ounces per square yard.
